(19) United States
(12) Patent Application Publication
(10) Pub. No.: US 2005/0089310 A1
(43) Pub. Date: Apr. 28, 2005

(54) Announcing device for entertainment systems

(76) Inventor: Addison M. Fischer, Naples, FL (US)

Correspondence Address: NIXON & VANDERHYE, PC, 1100 N GLEBE ROAD, 8TH FLOOR, ARLINGTON, VA, 22201-4714, US

(21) Appl. No.: 10/975,463

(22) Filed: Oct. 29, 2004

Related U.S. Application Data
(63) Continuation of application No. 08/310,337, filed on Sep. 22, 1994, now abandoned.

(51) Int. Cl. H04N 5/781

(52) U.S. Cl. 386/96; 386/125

(57) ABSTRACT

A media reader, such as a compact disc or video disk reader is described in which information about the performances on the media is stored in the player and is audibly rendered when a user requests the information via a remote control device. The performance information in the case of a compact disc will be the music or other audio information to be played. In the case of a video disk, the performance information will be the movie or other video information to be played. The information that can be requested by the listener may be the identity of a previous, current, or future selection, may be the duration of a selection, may be the identity of a composer, artist, or orchestra, or may be other information concerning the performance that is included in the directory of the media from which the performance is rendered.

### FIELD OF THE INVENTION

This invention relates to entertainment systems such as compact disc players and video disk players. More particularly, this invention relates to methods and apparatus for announcing information about compact disc and/or video disks loaded into an entertainment system.

### BACKGROUND OF THE INVENTION

With presently known compact disc and video disk players, when a listener inserts the disk into the player, the player reads certain information about the contents of the disc from a directory on the disc itself. That is, the disc contains both performance data (such as a song or a movie) and information data about the performance (such as the title or producer of the song or movie). Thus, in addition to the performance that is expected to be rendered audibly or visibly when the disc is played, the discs are also formatted with directories containing information about the performances contained on the disk and where they can be located on the disk. By known methods, these directories of information tell the compact disc or video disk player what performances are on a disk and where the player can find the performances that a user may request. These directories also have the capacity to contain, and sometimes do contain, other information about the performance. The directory is usually provided in a known digitally encoded form (such as ASCII).

Even though the directory information is read by the compact disc or video disk player, it is not conveniently available to the listener. During the playing time, a current selection may be identified to the listener only by a digital display on the front of the compact disc player and only by the disk number, track number, and playing time of a particular selection. This rudimentary information about a currently playing compact disc is thus available to a listener at the face of the compact disc player, but is not necessarily conveniently available to the listener.

The rudimentary information provided on the face of some compact disc players is also not specific enough to satisfy most listeners. With current players, obtaining more specific information than that provided on the face of the player is a laborious process. With current devices, for example, the listener loads multiple compact discs into the compact disc player and plays selections from the compact discs in various orders and arrangements. If, during the course of the performance, the listener wishes to know some information (such as the title) of a current selection, the user must note from the face of the player the disk number and the track number of the selection desired and must then either interrupt the music (or remember the disk and track number until the end of the performance), unload the compact discs to identify which compact disc corresponded to the desired track number being played, and then study either the compact disc label or the literature in the package accompanying the compact disc (assuming it is available) to learn the specific information desired. To resume the playing operation, the listener must reload the compact disc and reposition the player to the appropriate disk and track selection where the interruption occurred. With today's technology, these laborious steps are required even to learn such simple information as the title of a selection.

The difficulty in obtaining information about a current selection on a compact disc or video disk is particularly notable when the listener wishes to inquire about the current selection, but is unable to easily assess the compact disc player. For example, when a listener is operating an automobile while listening to a series of compact discs that have been preloaded into the compact disc player, the complicated procedure of interrupting the music, identifying the appropriate disk and track, and finding information about the current selection by reviewing the disk literature or literature accompanying the disk can be especially awkward and dangerous.

Some compact disc and video disk players do present some limited information about currently played selections, but display the information in letters on the player which may not be readily visible to listeners unless they are close enough to be able to make out the characters.

It would be desirable to provide a compact disc system and a video disk system which did not require the listener to interrupt the music or video being played to conveniently learn detailed information about the music or video performances. It would be desirable to provide the information more conveniently to the listener than by requiring the listener to move close enough to the player display to read a display.

### SUMMARY OF THE INVENTION

The present invention is an improvement over prior media players, such as compact disc and video disk systems, in that it may announce audibly requested information about a performance being rendered by the player. In one embodiment of this invention, information about the performances is audibly rendered after a request by the user through a remote control device associated with the media player. Operation of the remote control device instructs the player which information was requested and precipitates the audible rendering of the requested information.

The present invention may render the requested information through a voice synthesizer and a speaker. The speaker may be included in the compact disc or video disk player or, alternatively, may be included on the remote control device itself. In still another embodiment of the present invention, the information requested may be displayed on a remote control device rather than (or in addition to) being rendered audibly.

In certain embodiments of the present invention, the invention audibly renders information provided on the directory of the media being played as well as additional information not contained on the directory such as the current elapsed playing time. Information that may be available to the listener of a performance in accordance with the present invention includes the title of a selection currently playing, how long the selection will play, how much time has already elapsed since the current selection began, how much time has elapsed since the compact disc began, how much time has elapsed since the listening session began, who the composer, vocalist, or orchestra of a selection is, who the leading actor or actress of a video selection is, what the next selection to be played is, what the previous selection played was, who the author of a selection is, the date a selection was composed, produced or rendered, or any other pertinent information available or obtainable about any particular selection on the media.

The announcements of information may be prompted by a specific demand of the listener, or may occur automatically at a particular point within each performance. Thus, for example, the announcements for a compact disc may occur automatically once per album, once per song, at the beginning of a selection, or at the end of a selection, etc.

The present invention may be used in an audio compact disc player, where the voice synthesizer announces (verbally) some, or all, of the information stored on the compact disc. The invention may also be applied to video technology, where the information may be announced either audibly (through a channel for sound), or visually (through video signal generation).

Solely as an example, “current selection” information that may be audibly announced by the present invention may take the form of:
“Handel's Fifth Symphony, Second Movement” or
“‘The Music of the Night’, from ‘The Phantom of the Opera’ by Andrew Lloyd Webber”.

Another example of the information that may be announced by the present invention is the number of the compact disc that is playing, which may take the form of:
“Disk number four: The Classical Series of Famous Composers, by the London Symphony Orchestra” or
“Disk number three: The Premier Collection of the Best of Andrew Lloyd Webber—The Original Recordings”.

In one embodiment of the present invention, the information that is announced is mingled with the audio signals to produce a “voice-over”. In another embodiment of the present invention, the currently played audio is attenuated while the announcement is made. In still another embodiment of the invention, the music is paused or muted while the announcement is made.

In one embodiment of the present invention, the request for an announcement is made by a remote control device. In another embodiment, the announcement is made by other signal generations, such as a voice recognition device or a hand clap recognition device.

While many of the embodiments are described in the context of a compact disc player, this is solely an example of how the invention may be used with any media player. The invention may be used in video devices or any other media containing auxiliary information in a form which can be isolated and presented audibly or visually on demand. This includes general magnetic media, optical media, electronic media, laser disks, digital tapes, and “solid state” devices, which are capable of storing audio and/or video works.

In still another embodiment of the present invention, a compact disc player audibly reads the information from a compact disc or a batch of compact discs, at the time they are loaded. The user is then able to step through the information as it is read, and mark as either “desired” or “not desired” particular selections in the batch of compact discs. “Desired” selections would then be played while “non-desired” selections would be skipped automatically by the compact disc player.

### BRIEF DESCRIPTION OF THE DRAWINGS

These and other features and advantages provided by the present invention will become better and more completely understood by studying the following detailed description of presently preferred exemplary embodiments in conjunction with the drawings, of which:

FIG. 1 is a schematic view of an example embodiment of the present player and remote control;

FIG. 2 is a flow chart illustrating an example method of the present player;

FIG. 3 is a schematic view of another example embodiment of the present player and remote control; and

FIG. 4 is a schematic view of another example embodiment of the present player and remote control.

### DETAILED DESCRIPTION OF THE PRESENTLY PREFERRED EMBODIMENT

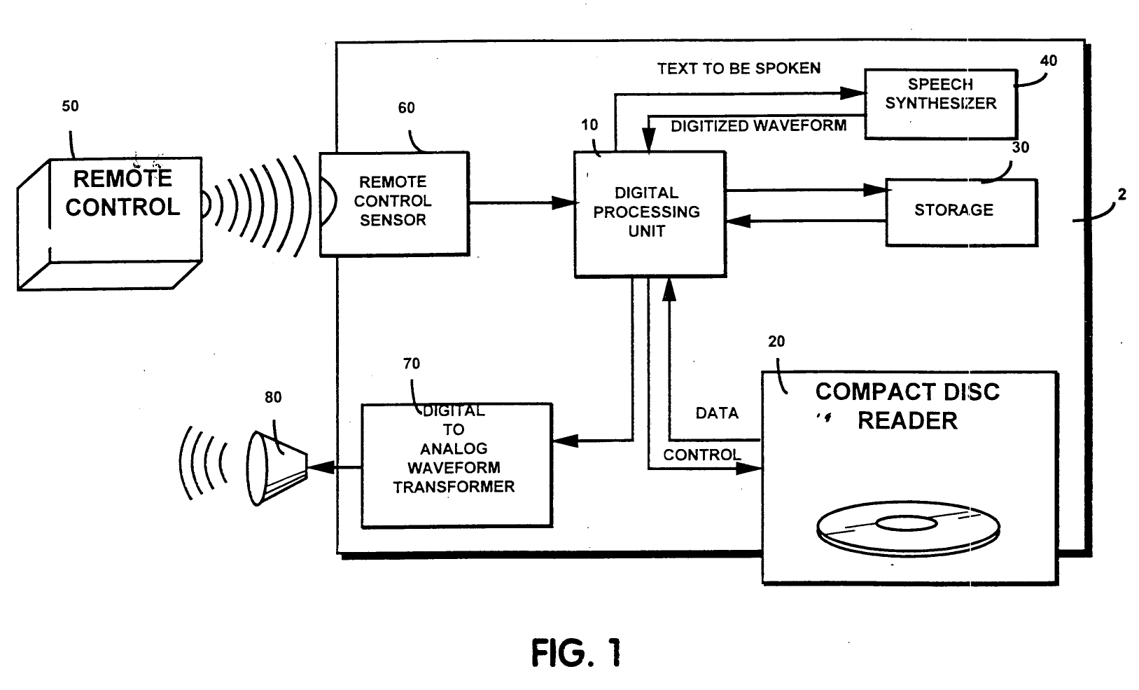

FIG. 1 shows one embodiment of the present invention including a compact disc player 2 and a remote control 50. The compact disc player 2 includes a digital processing unit 10 electrically connected to a compact disc reader 20 via both data and control lines. The compact disc reader 20 reads data signals from the compact disc media, converts them to a form appropriate for processing, and transmits them to storage device 30. In the embodiment shown in FIG. 1, the compact disc reader 20 outputs the data to a storage device 30 through the digital processing unit 10. The storage device 30 may be a RAM. The operation of the compact disc reader 20 is controlled by the digital processing unit 10.

The storage device 30 is accessed by the digital processing unit 10. The storage device 30 may store data including information from one or more media directories, the state of various components in the overall system, and information obtained from the user/remote control interface.

The digital processing unit 10 is also connected in two way communication to a speech synthesizer 40. Digital text to be spoken (such as ASCII text) is provided from the digital processing unit 10 to the speech synthesizer 40. Synthesizer 40 converts the digital text into digitized audio waveforms and provides those waveforms back to the digital processing unit 10. The digital processing unit is connected to the digital-to-analog waveform transformer 70 which, in turn, is connected to the speaker 80. The waveform provided by the speech synthesizer 40 is channeled to the digital to analog waveform transformer 70 through the digital processing unit 10.

In the embodiment shown in FIG. 1, the digitized audio waveform from the speech synthesizer 40 to the digital processing unit 10 may be mixed with the data from the compact disc reader 20 in the digital processing unit 10. The mixing may take one of several alternative forms. It may involve mixing the digitized audio waveform from the speech synthesizer 40 with the data from the compact disc reader 20 (one on top of the other). It may involve pausing the data from the compact disc reader 20 while allowing the digitized audio waveform from the speech synthesizer 40 to pass to the digital-to-analog waveform transformer 70. It may include attenuating the data from the compact disc reader 20 while allowing the digitized audio waveform from the speech synthesizer 40 to pass to the digital-to-analog waveform transformer 70 as a dominant audio signal. The digital processing unit 10 may be pre-programmed to provide a particular “mixing” scheme or may be programmed to select a “mixing” scheme based on a request by the user.

The player 2 is operated remotely by a remote control device 50, which is similar to the device commonly used to remotely control televisions, VCRs, compact discs, and other consumer equipment. The present remote control device 50 also allows the listener to signal a request for information about a performance as is more fully described below.

The player 2 includes a remote control sensor 60 which receives commands from the remote control 50. The remote control sensor 60 may sense sonic, infra-red, radio, or other electromagnetic signals generated by the user, or the user's remote control device. In the embodiment shown in FIG. 1, the remote control device 50 and the remote control sensor 60 are designed to transmit and receive infra-red signals, but in other embodiments, the remote control device 50 may be simply an operator's voice, a hand clap, or some other signal generator. In these embodiments, the remote control sensor 60 would be an appropriate device to receive the transmitted signal, such as a receiver, a voice detector or sound detector.

The remote control sensor 60 may perform various degrees of filtering or signal analysis on the signal transmitted from the remote control 50, before providing the signal from the remote control sensor 60 to the digital processing unit 10.

Some components shown in FIG. 1 may encapsulate various of the components illustrated. For example, in FIG. 1, signals from the media reader 20 and the speech synthesizer 40 are digital, and are converted to their analog form by a separate digital-to-analog waveform transformer 70. Alternatively, the digital-to-analog waveform transformer 70 may be part of the digital processing unit 10, the speech synthesizer 40, or the speaker 80. For example, speaker 80 may include the ability to directly process digital signals into analog waveforms and internally amplify the incoming signal, thus encapsulating the speaker 80 and digital-to-analog waveform transformer 70 into one component.

The components illustrated in FIG. 1 may also be implemented in a variety of alternate combinations. For example, in some embodiments, storage 30 may be directly coupled to the compact disc reader 20, rather than connecting through the digital processing unit 10. In addition, data from the media may come from multiple media units to be stored, recognized and managed by the digital signal processor 10. Further, mixing can be performed in a separate mixer, rather than in the digital processing unit.

In operation, the digital processing unit 10 prompts the compact disc reader to read the data from the media. The data includes information from the compact disc directory, which is loaded into RAM digital storage unit 30 through the digital processing unit 10. All of the digital data that is retrieved from the directory of the compact disc reader can be loaded into storage device 30 immediately after loading the compact discs into the player 2, or can be delayed and read selectively upon request from the listener.

By collecting the digital data from the compact disc as an initial step, and loading the information into RAM storage 30, user queries at a later time can be satisfied without interrupting the compact disc reader 20 during play. If the directory information is not collected as an initial step, the player 2 may incorporate less RAM memory in the storage unit 30, but may require interrupting the music being read by the compact disc reader 20 when the user requests information. In the latter embodiment, after a user query is received, the compact disc reader 20 interrupts the play of music, repositions the reader to the directory on the compact disc, fetches the desired information, announces it, then repositions the reader to resume play at the point of interruption. In the former embodiment, the information can be retrieved directly from storage 30, without interrupting the reader 20.

Once the directory data is obtained from either RAM storage 30 or reader 20 in response to a user query via the remote control unit 50, the digital processing unit 10 delivers the information requested to the speech synthesizer 40 for conversion into a digitized audio waveform. The digital processing unit 10 then outputs the directory data to the digital-to-analog waveform transformer 70 or mixes the directory data with the performance data coming from the compact disc reader 20 and outputs the mixed signals to the digital-to-analog waveform transformer 70. The digital-to-analog waveform transformer 70 then outputs the signal to the speaker 80 where the queried information is delivered to the user by an audible response.

To facilitate the input of queries from the user, the remote control device 50 may include an “announce” key, which may be augmented by other option keys. For example, depressing the announce key followed by a 1 key may refer to a request to announce the title of the current selection, depressing the announce key followed by a 2 key may request an announcement of the artist of the current selection, depressing the announce key followed by the 3 key may request an announcement of the author of the current selection, and so forth. Depressing the announce key followed by the 7 key followed by the 2 key may request an announcement of the artist of the seventh selection on the compact disc. Other options for identifying the query to the player 2 may be used.

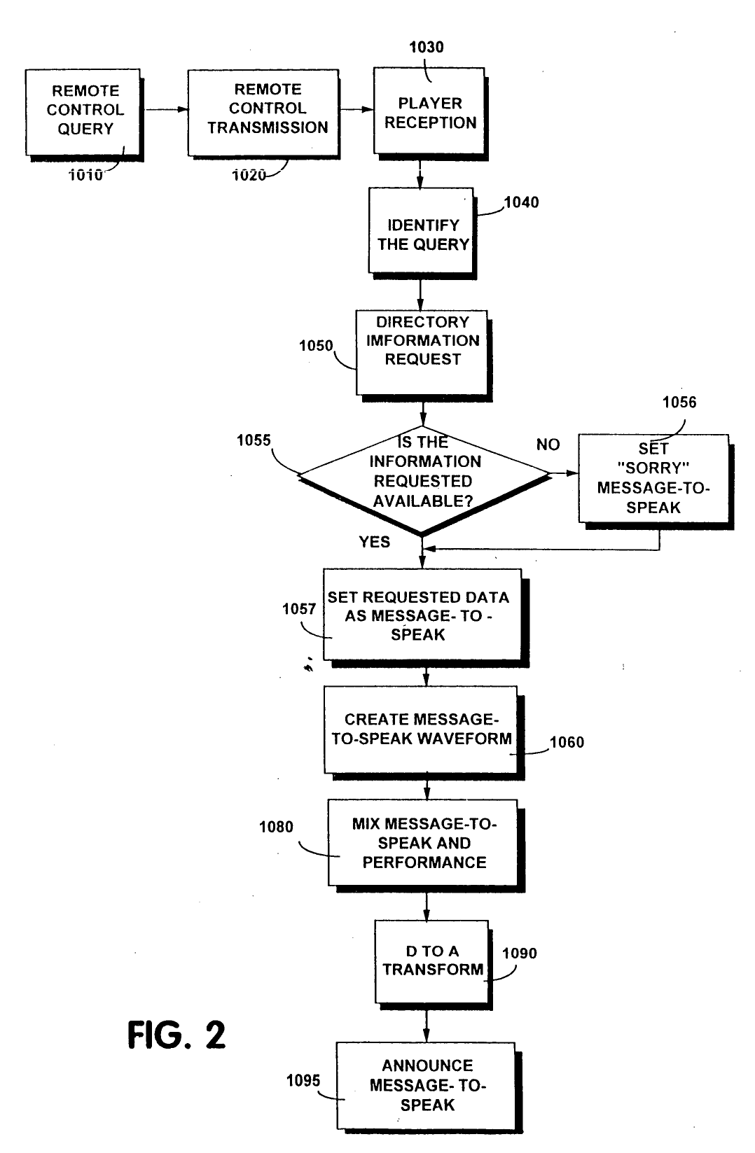

The operation of the present announcing system is now described with particular reference to the flowchart of FIG. 2. At step 1010, the user operates the query control button on the remote control 50. Thereafter, at step 1020, the query is converted to control pulses, such as infra-red, sonic, radio, etc., and are transmitted to the remote control sensor 60. At step 1030, the player device receives and interprets the control pulses from the remote control 50 using the remote control sensor 60.

At step 1040, once the request is received by the player 2 at the remote control sensor 60, the request is processed in the digital processing unit 10 to determine the type of data being requested, for example, the album title, song title, author, artist, selection index or duration, for a current, next, or some specified selection or track. At step 1050, the digital processing unit 10 requests directory information from storage device 30 in response to the query request from the remote control device 50. At step 1055, an inquiry is made to determine if the requested information is available. At step 1056, if the desired information is not available from the storage device 30, then digital processing unit 10 generates a message-to-speak signal indicating that the information is not available. In this case, for example, the message-to-speak may result in a message announcement of “sorry, unknown”. If at step 1055 the message information is available, the requested information is retrieved from the storage device 30 and is established as the message-to-speak in step 1057.

At step 1060, the message-to-speak is output from the digital processing unit 10 to the speech synthesizer 40 to create the message sound waveform in a digital state. At step 1080, the message-to-speak digital waveform is mixed with the digital performance waveform generated by the compact disc reader 20. The mixing may occur by superimposition, by substitution, or by suspending the performance and resuming the performance after the announcement is complete. Each of these implementations involves particular processing which should be evident to those skilled in the art of digital signal mixing.

At step 1090, the resulting waveform from the mix of the message-to-speak and the performance data is supplied to the digital-to-analog waveform transformer 70. At step 1095, the digital-to-analog waveform transformer 70 delivers the resulting waveform to the speaker which makes the response audible.

The storage device 30 may be initially loaded with the directory data in ASCII format or in digital waveform format (i.e., after the data is processed by the speech synthesizer). In the latter case, when the query is received, the announced information could be presented straight to the D to A transformer 70 from the storage device 30 without going through the speech synthesis step.

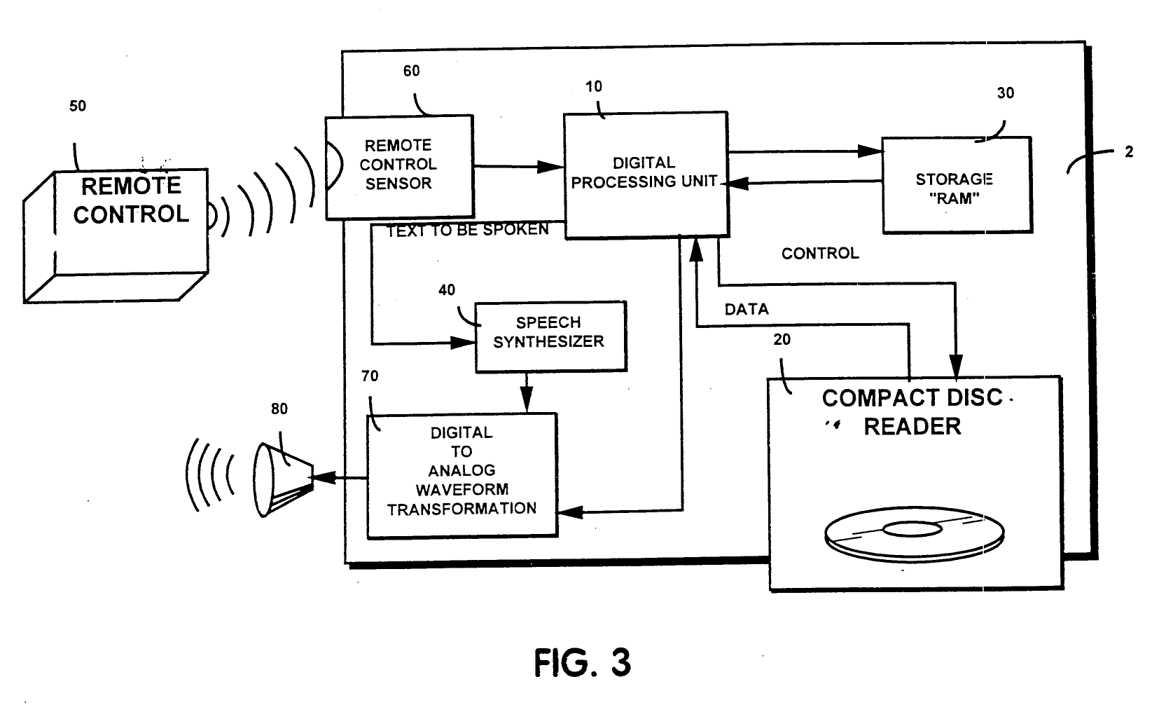

FIG. 3 is an alternative embodiment of the present invention in which the speech synthesizer 40 is directly connected to the digital-to-analog waveform transformer 70, without routing through the digital processing unit 10. Preferably, the output of the speech synthesizer 40 is controlled by (and through) the digital processing unit 10, but in the embodiment of FIG. 3, the output of the speech synthesizer 40 is received directly by the digital to analog transformer 70. The apparatus of FIG. 3 operates similarly to that described with respect to FIGS. 1 and 2, except that the waveform from the speech synthesizer is not processed by the digital processing unit 10. In the embodiment of FIG. 3, mixing of the synthesizer 40 output and the data from the reader 20 could occur in a separate mixer, may not occur at all, or may be delivered to separate speakers for simultaneous announcement.

In still another embodiment of the present invention, the compact disc reader provides data directly to the D to A waveform transformer 70, without routing through digital processing unit 10.

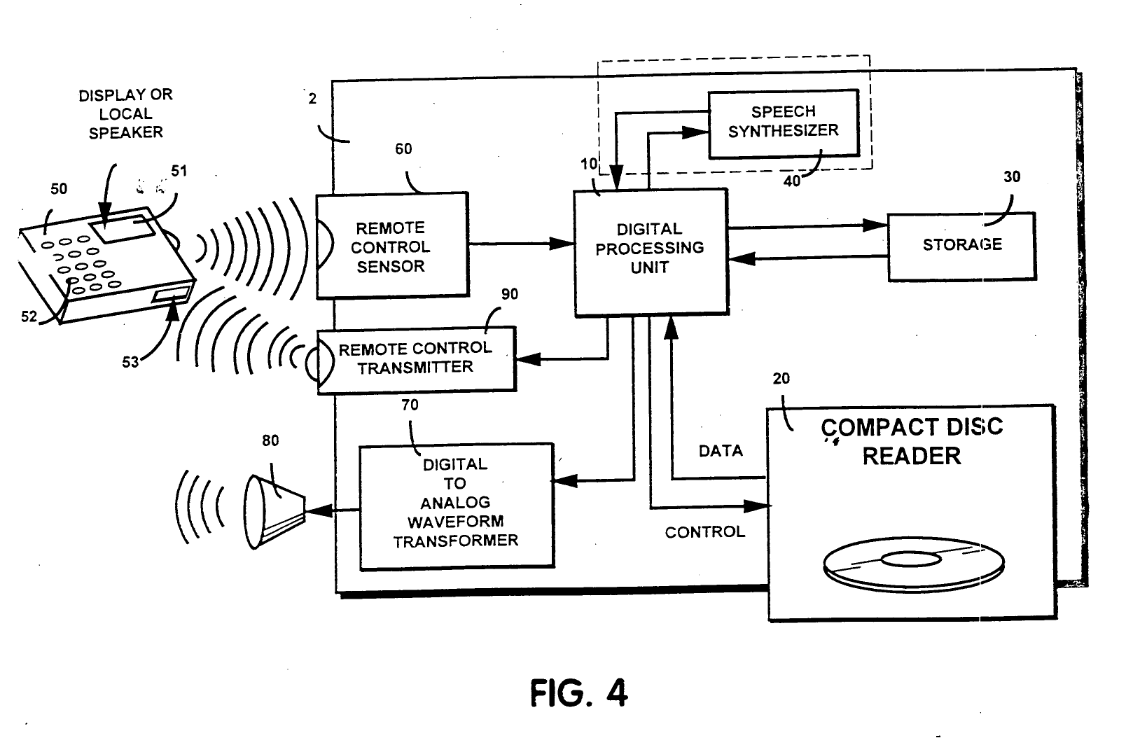

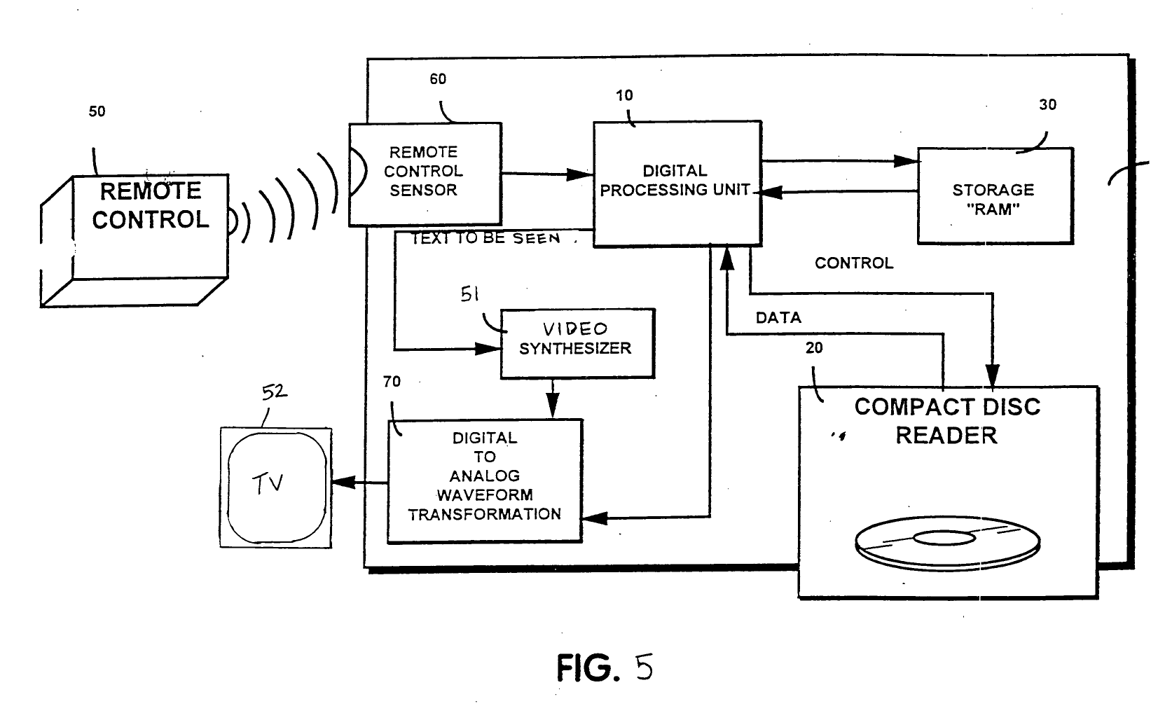

FIG. 4 is still another embodiment of the present invention in which the information being presented to the listener is presented through the speaker 80, the remote control 50, or both. As shown in FIG. 4, the remote control 50 may include a display 51 and a speaker 52 to present the information to the listener in addition to, or in lieu of, an announcement by speaker 80. In this embodiment, the listener makes the information query through keys on the remote control 50, which causes the remote control 50 to transmit the query to the remote control sensor 60 on the player 2. Just as in the apparatus of FIG. 1, the remote control sensor 60 then provides the query to the digital processing unit 10 which retrieves the information from storage 30 and mixes it with the audible program data coming from the compact disc reader 20. The digital processing unit 10 can then provide the mixed signal to the digital-to-analog waveform transformer 70 for broadcast over the speaker 80, or can provide the queried information from the storage unit 30 (mixed or unmixed with the program data from compact disc reader 20) to the remote control responder 90. Remote control responder 90 then transmits the requested information to the response receiver 53 of the remote control 50. The remote control 50 then processes the information, including the speech synthesis and D to A transform steps, and displays the information on the LED 51 or “speaks” the information to the listener through the speaker 52, or both.

In the embodiment of FIG. 4, the speech synthesis operation can occur in the speech synthesizer 40 if speaker 80 is to announce the requested information; or, alternatively, the speech synthesis can occur in the remote control unit 50. In this latter instance, the speech synthesizer 40 would be incorporated into remote control 50 rather than player 2. Then the player 2 transmits the requested information by the remote control responder 90 to the remote control 50 in, for example, ASCII format. The remote control 50 then processes the ASCII data into a digital waveform for display to the user on a LCD or LED display 51 or synthesizes the information into an analog waveform and announces the answer to the user through the speaker 52.

The above description is of illustrative embodiments of the present invention and the invention is not limited to the specific embodiments described. Rather, the present invention covers all obvious modifications of the above described embodiments that do not depart from the spirit and scope of the present invention.

1. A media player for use with a media containing both prerecorded performance data and prerecorded information data describing the performance data, comprising:
a housing;
a media reader to read and output the performance data and information data from the media;
a processor, in electrical communication with the media reader, to input the performance data and the information data from the media reader, to receive a command signal generated outside of the housing, to select certain of the information data based on the command signal, and to output the selected information data; and
an announcer, in electrical communication with the processor, to render the performance data and the selected information data.

2. A media player according to claim 1, wherein the announcer audibly renders the selected information data.

3. A media player according to claim 1, wherein the announcer visibly renders the selected information data.

4. A media player according to claim 1, wherein:
the processor mixes the performance data and the selected information data into a mix signal, and
the announcer renders the mix signal.

5. A media player according to claim 1, wherein the processor includes a memory device for prestoring the information data.

6. A media player according to claim 1, wherein the announcer further includes:
a speech synthesizer, in electrical communication with the processor, to convert the selected information data into an digital audio waveform;
a digital to analog transformer, in electrical communication with the synthesizer, to convert the digital audio waveform into an analog audio waveform; and
a speaker, in electrical communication with the digital to analog transformer, to audibly render the analog audio waveform.

7. A media player according to claim 1, further including a remote control to generate the command signal, the remote control including the announcer and a receiver, the media player further including:
a transmitter, in electrical communication with the receiver of the remote control, to transmit the selected information data to the remote control.

8. A media player according to claim 7, wherein the announcer further includes:
a speech synthesizer, in electrical communication with the receiver, to convert the selected information data into an digital audio waveform;
a digital to analog transformer, in electrical communication with the synthesizer, to convert the digital audio waveform into an analog audio waveform; and
a speaker, in electrical communication with the digital to analog transformer, to audibly render the analog audio waveform.

9. A media player according to claim 7, wherein the announcer includes a speaker, the media player further including:
a speech synthesizer, in electrical communication with the processor, to convert the selected information data into a digital audio waveform; and
a digital to analog transformer, in electrical communication with the synthesizer, to convert the digital audio waveform into an analog audio waveform, whereby the transmitter transmits the analog audio waveform to the receiver of the remote control.

10. A remote control for a media player capable of reading and outputting media containing both prerecorded performance data and prerecorded information data describing the performance data, comprising:
selectors, including:
performance selectors to select certain of the performance data and output corresponding performance data selection signals; and
information selectors to select certain of the information data and output corresponding information data selection signals;
a transmitter, in electrical communication with the media player,
to generate and transmit, in response to the performance data selection signals, a request to the media player to read and output the selected performance data, and
to generate and transmit, in response to the information data selection signals, a request to the media player to read and output the selected information data.

11. A remote control according to claim 10, whereby the selectors are keys, the remote control further including:
a receiver, in electrical communication with the media player, to receive the selected information data from the media player; and
an announcer, in electrical communication with the receiver, to render the selected information data.

12. A remote control according to claim 11, wherein the announcer includes a display.

13. A remote control according to claim 11, wherein the announcer includes a speaker.

14. A remote control according to claim 11, wherein the announcer includes:
a speech synthesizer, in electrical communication with the receiver, to convert the selected information data into an digital audio waveform;
a digital to analog transformer, in electrical communication with the synthesizer, to convert the digital audio waveform into an analog audio waveform; and
a speaker, in electrical communication with the digital to analog transformer, to audibly render the analog audio waveform.

15. A method of rendering prerecorded performance data and prerecorded information data from a media, comprising the steps of:
1) inputting a query for certain of the information data to be rendered;
2) retrieving the information data from memory storage;
3) converting the information data into an audio information waveform;
4) mixing the audio information waveform into the performance data to obtain a mix audio signal; and
5) audibly rendering the mix audio signal.

16. A method according to claim 15, wherein the memory storage is the media and step 2) includes retrieving the information from the media.

17. A method according to claim 15, wherein:
step 3) includes converting the information data into a digital audio information waveform,
step 4) includes mixing the digital audio information waveform into the performance data to obtain a digital mix audio signal,
the method further including, after step 4) and before step 5), the step:
4A) converting the mix digital audio signal into a mix analog audio signal, and wherein:
step 5) includes audibly rendering the mix analog audio signal.

18. A method according to claim 15, wherein step 4 includes the step of superimposing the performance data and the audio information waveform.

19. A method according to claim 15, wherein step 4 includes the steps of:
4A) attenuating the performance data; and
4B) superimposing the audio information waveform into the attenuated performance data to obtain the mix audio signal.

20. A method of rendering prerecorded performance data and prerecorded information data from a media, comprising the steps of:
1) audibly rendering the performance data;
2) inputting a query for certain of the information data to be rendered;
3) retrieving the information data from memory storage;
4) converting the information data into an audio information waveform; and
5) audibly rendering the audio information waveform.

21. A method according to claim 20, further including the step, before step 5), of:
4A) muting the audible rendering of the performance data;
and further including the step, after step 5), of
6) audibly rendering the performance data.

22. A method of rendering prerecorded video performance data and prerecorded information data from a media, comprising the steps of:
1) inputting a query for certain of the information data to be rendered;
2) retrieving the information data from memory storage;
3) converting the information data into a video information waveform;
4) superimposing the video information waveform into the video performance data to obtain a video mix signal; and
5) visually rendering the video mix signal.

23. A method of rendering prerecorded video performance data and prerecorded information data from a media, comprising the steps of:
1) visually rendering the prerecorded video performance data;
2) inputting a query for certain of the information data to be rendered;
3) retrieving the information data from memory storage;
4) converting the information data into an audio information waveform; and
5) audibly rendering the audio information waveform.
